(19) United States
(12) Patent Application Publication
(10) Pub. No.: US 2013/0327155 A1
(43) Pub. Date: Dec. 12, 2013

(54) Ultrasonic Flow Meter

(71) Applicant: Jens Drachmann, Viby J (DK)

(72) Inventor: Jens Drachmann, Viby J (DK)

(73) Assignee: MIITORS APS, Horsens (DK)

(21) Appl. No.: 14/001,010

(22) PCT Filed: Feb. 20, 2012
(86) PCT No.: PCT/DK2012/050056

§ 371 Date: Aug. 22, 2013

(30) Foreign Application Priority Data
Feb. 23, 2011 (DK) PA 2011 00124

(51) Int. Cl. G01F 1/66

(52) U.S. Cl. CPC G01F 1/66
USPC 73/861.18

(57) ABSTRACT

An ultrasonic flow meter is disclosed comprising at least one ultrasonic transducer, wherein the transducer comprises a piezoelectric disc, a nonconductive polymeric material and an electrically conductive layer between the piezoelectric disk and the nonconducting polymeric material.

### FIELD OF THE INVENTION

The present invention relates to ultrasonic flow meters comprising ultrasonic transducers, especially consumption meters for water, gas and heat.

### BACKGROUND OF THE INVENTION

In recent years, ultrasonic flow meters have entered high volume markets, such as utility meters for gas, water and heat consumption. The reasons for the success in these markets are increasing performance, falling prices and relatively easy integration of remote reading of these meters. Continued increase in market penetration of these meters depends on further optimizations and price reductions.

Simplified mechanical design is one way of lowering the costs of production of ultrasonic flow meters, and paced development in this area has been seen in the last 20 years. The production, assembly and electrical connection of the transducers are especially important in an optimized design, as this is a major cost in the production of ultrasonic flow meters.

Ultrasonic flow meters are divided into two subgroups based on two different technologies: the Doppler flow meters utilizing the Doppler effect of ultrasound reflected on particles or bubbles in the flowing media and transit time flow meters utilizing time differences between ultrasound beams transmitted upstream versus downstream in the flowing media. Operation of the two different types of meters is thoroughly described in patent literature and elsewhere. Of particular relevance is the fact, that whereas Doppler flow meters can be implemented using only one ultrasonic transducer, the transit time meters need at least two transducers. This means that transducer production cost is particularly important in transit time flow meters. Still, due to a higher dynamic range, transit time flow meters are often preferred in electronic flow meters for billing purposes.

Most ultrasonic transducers consist of an assembly including a piezoelectric ceramic disk. Very often, these disks are activated by asserting an alternating electric field on the disks achieved by application of an alternating voltage on electrodes on the flat sides of the disks. Due to the piezoelectric nature of the disks, this evokes a mechanical movement resulting in acoustical waves transmitted from the disks.

In practical situations, this means that one side of a disk is obscured by the media that is going to be examined by the flow meter, or alternatively an intermediate layer between the media and the disk obscures one side of the ceramic disk. The obscured side of the ceramic disk needs special attention, because application of an alternating voltage to the electrode on this side of the disk is more complicated, as the electrode on this side is hidden. If an electrically conductive intermediate layer is used, an electrical signal can be applied to the intermediate layer next to the ceramic disk in order to assert an electrical signal to the obscured electrode. A prerequisite for this to succeed is the use of electrically conductive glue, a very thin layer of dielectric material or a direct electrical connection between the intermediate layer and the electrode. All of these solutions have already been shown previously in the literature.

For reasons of production costs, increased use of polymeric materials have been seen in flow meters and, by nature, these materials are electrically nonconductive. Using a nonconductive polymeric material for the intermediate layer in an ultrasonic transducer increases the complexity of applying an electric signal to the electrode on a piezoelectric ceramic disk, which is held against such a material. An example of a solution is shown in EP 2 236 995, FIG. 3B. Here, a metallic spring is pressed against the obscured electrode from beneath (between the disk and the polymeric material), and electrical access to the electrode is then enabled via the spring. Unfortunately, this solution has a cost in terms of constraints on the mechanical solution and, in addition, the number of mechanical parts involved is high, which means higher component costs and higher costs of assembly. Further, the area of contact between the piezoelectric disk and the intermediate polymeric layer is decreased because some of the surface area is used for the connection. This fact, in turn, lowers the overall efficiency of the transducer.

An alternative solution for accessing the obscured electrode exists, which includes prolonging the electrode up on the sides of the disk and onto the upper side of the disk (a so-called wrap-around electrode) but this solution has a significantly higher cost in production of the piezoelectric disk.

### BRIEF DESCRIPTION OF THE INVENTION

It is an object of the present invention to provide a cost effective ultrasonic transducer for ultrasonic based flow meters in which a nonconductive polymeric material is placed between the media to be metered and the side of a piezoelectric ceramic disk facing the media to be investigated.

The present invention relates to an ultrasonic flow meter comprising at least one ultrasonic transducer, wherein the transducer comprises a piezoelectric disc, a nonconductive polymeric material and an electrically conductive layer between the piezoelectric disk and the nonconducting polymeric material.

In an embodiment of the invention, the ultrasonic flow meter comprises at least two ultrasonic transducers, wherein each of the transducers comprises a piezoelectric disc, a nonconductive polymeric material and an electrically conductive layer between the piezoelectric disk and the nonconducting polymeric material.

In an embodiment of the invention, the nonconducting polymeric material of the at least two transducers is made of one monolithic piece of material.

In an embodiment of the invention, the electrically conductive layers of the two transducers are electrically connected by a connecting electrically conductive layer deposited on the nonconducting polymeric material.

In an embodiment of the invention, the nonconducting polymeric material forms a part of a housing for an electronic circuit.

In an embodiment of the invention, the housing is formed as a hermetic enclosure containing the one or two transducers as well as the electronic circuit.

In an embodiment of the invention, the nonconducting polymeric material is a composite material reinforced by fibres, such as glass or mineral fibres.

In an embodiment of the invention, the electrically conductive layer is deposited on the nonconducting polymeric material using vapour deposition, such as chemical vapour deposition or physical vapour deposition.

In an embodiment of the invention, the ultrasonic flow meter further comprises a coupling layer between the electrically conductive layer and at least one electrode on the piezoelectric disc.

In an embodiment of the invention, the coupling layer is an electrically conductive adhesive.

In an embodiment of the invention, the electrically conductive adhesive comprises a mixture of a nonconductive glue and electrically conductive metallic balls, such as silver, gold, copper or nickel balls.

In an embodiment of the invention, the coupling layer is a dielectric material.

In an embodiment of the invention, the electrically conductive layer is electrically connected to an electronic circuit via an electrical conductor.

In an embodiment of the invention, at least a part of the electrical conductor is a flexible connection, such as a spring.

In an embodiment of the invention, the electrically conductive layer is at least partly reinforced by a protective layer.

In an embodiment of the invention, the protective layer is electrically conductive.

### FIGURES

A few exemplary embodiments of the invention will be described in more detail in the following with reference to the figures, in which

FIG. 1 illustrates a piezoelectric disk,

FIG. 2 illustrates a cross-section of a transducer assembly according to the invention,

FIG. 3 illustrates a cross-section of a flow meter according to the invention, and

FIG. 4 illustrates an exploded view of a complete flow meter according to the invention.

### DETAILED DESCRIPTION OF THE INVENTION

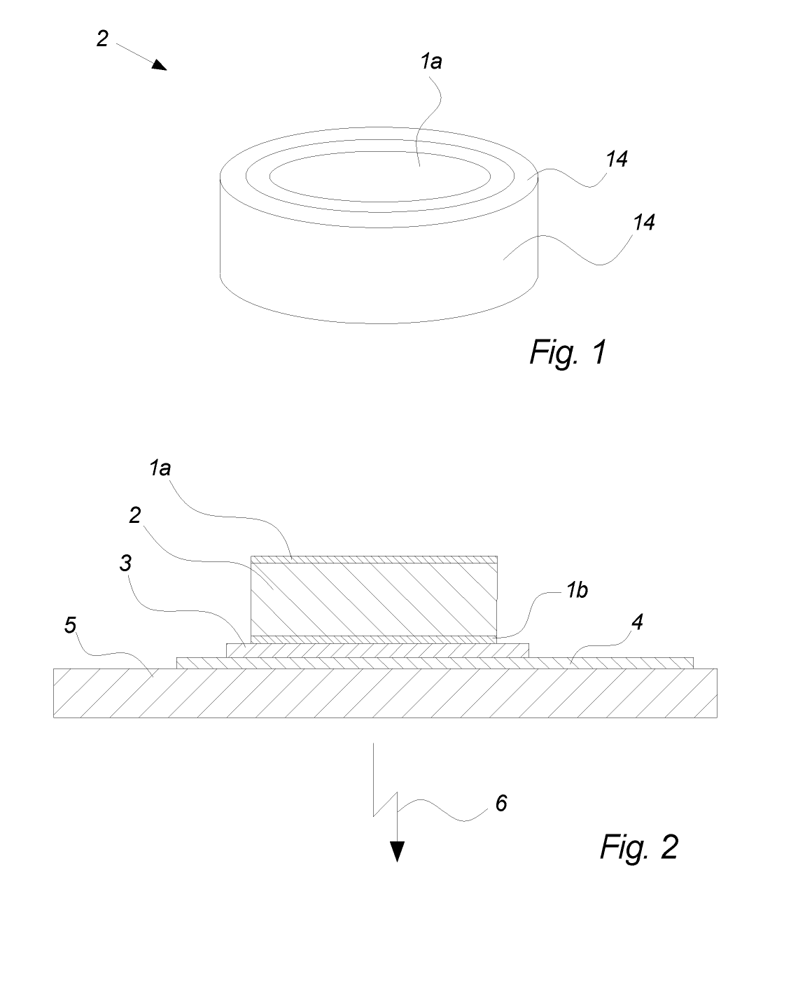

FIG. 1 illustrates a piezoelectric disk 2 with an electrode 14 prolonged up on the side and further onto the top side of the disk 2, so that access to the otherwise obscured electrode on the bottom side of the disk 2 is possible from the top side.

FIG. 2 illustrates a cross-section of a transducer assembly according to the invention. The piezoelectric disk 2 is mounted on the nonconductive polymeric material 5. Between the disk 2 and the polymeric layer 5 is an electrically conductive layer 4 and a coupling layer 3.

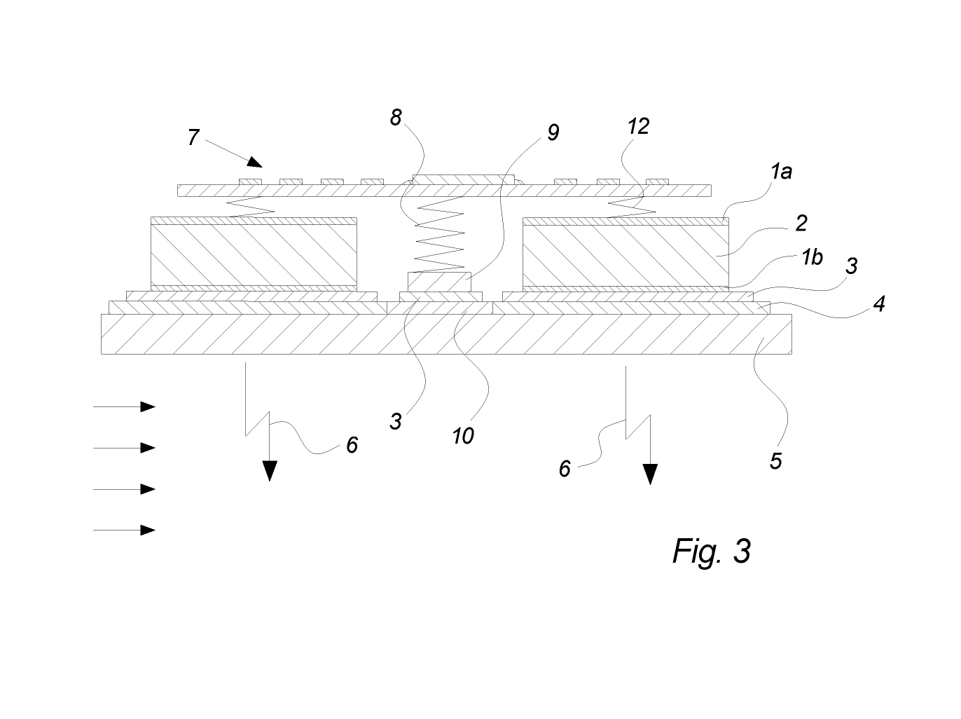

FIG. 3 illustrates a cross-section of a flow meter with two transducers 2 assembled by the methods described. The upper electrodes 1a on the piezoelectric disks 2 are connected to an electronic circuit 7 via flexible connections, and the bottom electrode 1b on the disks 2 are glued onto an electrically conductive layer 4 with an electrically conductive adhesive 3. The electrically conductive layer 4 is connected to the electronic circuit 7 via a flexible connection 8 and a protective layer 9, such as a metal plate, and a conductive adhesive.

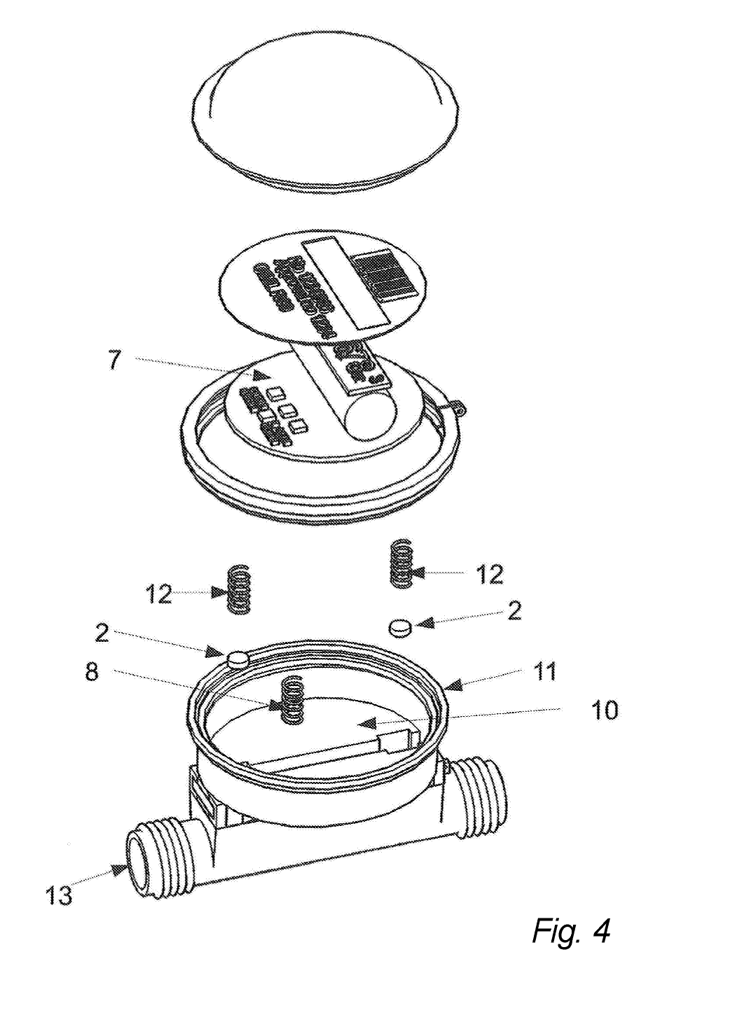

FIG. 4 illustrates an exploded view of a complete flow meter according to the invention. Some details, such as the protective layer 9, screws and other fixation means have been omitted for clarity.

Basically, the ultrasonic transducer according to the invention comprises a piezoelectric disk 2, a nonconductive polymeric material 5 and an electrically conductive layer on the nonconductive polymeric material 4

The piezoelectric disk 2 is typically made of a ceramic material such as Lead zirconate titanate (also called PZT). The disk 2 has conducting electrodes 1a, 1b on the flat sides of the disk 2, so that electrical signals can be applied to the material.

Optionally, the nonconducting polymeric material 5 can contain reinforcing fibres or materials such as glass, minerals or metals. Other materials can also be added to the polymeric material 5 to change the parameters and characteristics of the material 5 regarding such properties as strength, hardness, brittleness, density, acoustic impedance and others. In the case that one or more conductive materials are added to the polymeric material 5, it is still considered nonconducting in this context if the conductivity of the resulting polymeric material 5 is still insufficient to be used as electrical connection to an electrode 1b on the piezoelectric disk 2.

In some embodiments, it is preferred to use a piezoelectric disk 2 which differs from a perfectly plane disk in order to focus the resulting ultrasonic beam.

In order to allow electrical access to the obscured electrode 1b on the piezoelectric disk 2, an electrically conductive layer 4 is applied on the nonconducting polymeric material 5, and the piezoelectric disk 2 is mounted on the electrically conductive layer 4.

In a preferred embodiment, the electrically conductive layer 4 is applied by a vapour depositing process, such as physical vapour deposition, chemical vapour deposition or plasma enhanced chemical vapour deposition. Such methods and their properties are thoroughly described in the literature.

In a preferred embodiment, the electrically conductive layer 4 is a metallic layer such as aluminium, silver, chromium, gold, copper or stainless steel. Other feasible methods for applying the electrically conductive layer 4 are thick film deposition methods, such as screen printing or ink jet printing. Further ways of applying the electrical conductive layer 4 are processes, such as thermal spraying or plating.

Between the obscured electrode 1b on the piezoelectric disk 2 and the electrically conductive layer 4, a coupling layer 3 can be applied. The coupling layer 3 serves a double purpose as it assures proper acoustical coupling between the piezoelectric disk 2 and the polymeric material 5 and it also assures electrical coupling between the electrically conducting layer 4 and the electrode 1b on the disk 2. Although a coupling layer 3 is not strictly necessary for a transducer to function, it increases the reliability of operation.

In a preferred embodiment, an electrically conductive adhesive is used as the coupling layer 3. This holds the piezoelectric disk 2 in place and allows electrical connection between the electrically conducting layer 4 and the electrode 1b.

In a preferred embodiment, the conductive adhesive 3 is a nonconductive glue, such as epoxy, mixed with small conductive metallic balls such as gold, silver, aluminium or nickel balls. This is a known method in the art of assembling ultrasonic transducers. When the content of metallic balls is relatively low, such as less than 20%, the glue 3 is nonconductive because the conductive balls are too far apart from each other to touch each other. However, in a thin layer of the glue (the thickness comparable to the diameter of the metallic balls) the balls will short-circuit the glue 3, and electrical signals can pass. In this sense, the glue 3 is conductive. An important advantage in using this approach is that surplus glue 3 from the assembly process will not short-circuit transducers or other electrical circuits.

In another embodiment, a thin layer of a dielectric material such as oil or glycol is used for the coupling layer 3, as this has the advantage of lowered mechanical stress in the assembled transducer originating from differences in thermal expansion coefficients between the piezoelectric material 2 and the nonconductive polymeric material 5. An important downside to this solution, however, is that the piezoelectric disk 2 has to be held in place by other means, thus implicating a higher cost of components.

Although a dielectric material does not conduct electric charge, a thin layer will exhibit sufficient capacitive coupling to commute alternating currents. In this sense, the dielectric material 3 is conductive.

In a preferred embodiment, the one or more transducers are electrically connected to an electronic circuit 7 via the one or more electrical conductive layers 4. An especially optimal method is using metallic springs 12 as connections, as this is a flexible, low cost, and effective connection. The mechanical flexibility is especially important, as this will allow movements between the one or more transducers and the electronic circuit 7 caused by differences in thermal expansion coefficients, external vibrations or ultrasonic vibrations from the transducers. Flexible connections such as metallic springs 8 are also preferred as parts of the electrical connection between the electronic circuit 7 and the accessible electrodes 1a on the one or more transducers.

Optimization of the cost of the transducer results in a very thin electrically conductive layer 4. Thus, in a preferred embodiment, the electrically conductive layer 4 is, at least partly, reinforced, so that a metallic spring 8 will not damage the layer 4. Preferably, a small metal plate 9 is glued to the electrically conductive layer 4 using the same technology as described previously for the assembly of the piezoelectric disk 2 on the electrically conductive layer 4. The flexible electrical connection 8 is then connected to the metallic plate 9.

Using more than one transducer as described above in a flow meter is most advantageous, if the nonconductive polymeric material 5 used for the transducers is in one single monolithic piece. This lowers the number of components, and the cost of assembly.

In a preferred embodiment, the electrically conductive layers 4 of the transducers are electrically connected by a connecting electrically conductive layer 10. The connecting electrically conductive layer 10 is preferably produced at the same time as the electrically conductive layers 4 in the transducers.

In an especially beneficial embodiment, the single monolithic piece of nonconductive polymeric material 5 is used as a part 11 of a housing for the electronic circuit 7. FIG. 4 illustrates how such a housing may be formed as a hermetical enclosure containing the transducers as well as the electronic circuit 7. This solution further reduces production cost, because the assembly process is simplified, and a water-tight and protective enclosure for the electronics 7 may be produced in a very simple way.

Especially beneficial shapes of the electrically conductive layer 4 can be used, so that the electrically conductive layer 4 also serves other purposes, such as a functioning as a shield against external electrical or electromagnetic fields. Additionally, parts of the electrically conductive layer 4 can serve as one or more connections between other electrical or electronic components and a PCB. Finally, parts of the electrically conductive layer 4 can be designed in shapes so as to act as components, such as antennas, capacitive touch sensors or inductive coils for energy or signal transmissions. Connections between a printed circuit board and the additional uses of the electrically conductive layer 4 can be implemented using a metallic spring as described in this application, or other means of electrical connection can be used, such as wires or adhesive copper strips.

The present invention has been described with reference to preferred and advantageous embodiments. However, the scope of the invention is not limited to the specified forms and applications. Rather, it is limited only by the accompanying claims.

Certain specific details of the disclosed embodiments are elaborated for purposes of explanation rather than limitation, so as to provide a clear and thorough understanding of the present invention. However, it should be understood readily by those skilled in this art, that the present invention may be applied in other embodiments, which do not conform exactly to the details shown, without departing significantly from the spirit and scope of this disclosure. Further, in this context and for the purposes of brevity and clarity, detailed descriptions of well-known apparatus, circuits and methodology have been omitted so as to avoid unnecessary detail and possible confusion.

### LIST OF REFERENCE NUMBERS

1a. Accessible electrode on the piezoelectric disk
1b. Obscured electrode on the piezoelectric disk
2. Piezoelectric disk
3. Coupling layer
4. Electrically conductive layer
5. Nonconductive polymeric material
6. Ultrasonic wave emitted by the transducer into the media to be examined
7. Electronic circuit
8. Flexible connection from the protective layer to the electronic circuit
9. Protective layer
10. Connecting electrically conductive layer
11. Part of the housing for the electronic circuit
12. Flexible connection from accessible electrode on the piezoelectric disk to the electronic circuit
13. Conduit for the media to be examined.

1. An ultrasonic flow meter comprising at least one ultrasonic transducer, wherein the transducer comprises a piezoelectric disc, a nonconductive polymeric material and an electrically conductive layer between the piezoelectric disk and the nonconducting polymeric material.

2. The ultrasonic flow meter according to claim 1, further comprising at least two ultrasonic transducers, wherein each of the transducers comprises a piezoelectric disc, a nonconductive polymeric material and an electrically conductive layer between the piezoelectric disk and the nonconducting polymeric material.

3. The ultrasonic flow meter according to claim 2, wherein the nonconducting polymeric material of the at least two transducers comprises one monolithic piece of material.

4. The ultrasonic flow meter according to claim 2, wherein the electrically conductive layers of the at least two transducers are electrically connected by a connecting electrically conductive layer deposited on the nonconducting polymeric material.

5. The ultrasonic flow meter according to claim 1, wherein the nonconducting polymeric material comprises a part of a housing for an electronic circuit.

6. The ultrasonic flow meter according to claim 5, wherein the housing comprises a hermetic enclosure containing the one or two transducers as well as the electronic circuit.

7. The ultrasonic flow meter according to claim 1, wherein the nonconducting polymeric material comprises a composite material reinforced by fibres.

8. The ultrasonic flow meter according to claim 1, wherein the electrically conductive layer is deposited on the nonconducting polymeric material using vapour deposition.

9. The ultrasonic flow meter according to claim 1, further comprising a coupling layer between the electrically conductive layer and at least one electrode on the piezoelectric disc.

10. The ultrasonic flow meter according to claim 9, wherein the coupling layer comprises an electrically conductive adhesive.

11. The ultrasonic flow meter according to claim 10, wherein the electrically conductive adhesive comprises a mixture of a nonconductive glue and electrically conductive metallic balls.

12. The ultrasonic flow meter according to claim 9, wherein the coupling layer comprises a dielectric material.

13. The ultrasonic flow meter according to claim 1, wherein the electrically conductive layer is electrically connected to an electronic circuit via an electrical conductor.

14. The ultrasonic flow meter according to claim 13, wherein at least a part of the electrical conductor is a flexible connection, such as a spring.

15. The ultrasonic flow meter according to claim 1, wherein the electrically conductive layer is at least partly reinforced by a protective layer.

16. The ultrasonic flow meter according to claim 15, wherein the protective layer is electrically conductive.

17. The ultrasonic flow meter according to claim 7, wherein said fibres comprise at least one material selected from the group consisting of glass fibres and mineral fibres.

18. The ultrasonic flow meter according to claim 8, wherein said vapour deposition comprises at least one deposition selected from the group consisting of chemical vapour deposition and physical vapour deposition.

19. The ultrasonic flow meter according to claim 11, wherein said conductive metallic balls comprise at least one material selected from the group consisting of silver, gold, and copper.
